(19) United States
(12) Patent Application Publication
(10) Pub. No.: US 2025/0385630 A1
(43) Pub. Date: Dec. 18, 2025

(54) MOTOR CONTROL DEVICE

(71) Applicant: Hitachi Astemo, Ltd., Hitachinaka-shi, Ibaraki (JP)

(72) Inventors: Kodai TAKEDA, Tokyo (JP); Shun TANIGUCHI, Tokyo (JP); Takafumi HARA, Tokyo (JP); Fumihiro TAKAHASHI, Hitachinaka-shi, Ibaraki (JP)

(73) Assignee: Hitachi Astemo, Ltd., Hitachinaka-shi, Ibaraki (JP)

(21) Appl. No.: 18/877,370

(22) PCT Filed: May 31, 2023
(86) PCT No.: PCT/JP2023/020371

§ 371 Date: Dec. 20, 2024

(30) Foreign Application Priority Data
Jul. 29, 2022 (JP) 2022-122341

(51) Int. Cl. H02P 23/04; B60L 3/00; B60L 15/20; H02P 23/14; H02P 27/06

(52) U.S. Cl. CPC H02P 23/04; B60L 3/0061; B60L 15/2045; H02P 23/14; H02P 27/06; B60L 2240/423; B60L 2270/145

(57) ABSTRACT

A motor control device includes a torque ripple compensation value computation unit that calculates a torque ripple compensation value for compensating for torque ripple occurring in a motor based on an electrical angular velocity of the motor and a torque command value; a ripple amplitude upper limit value calculating unit that calculates a ripple amplitude upper limit value which is an upper limit value for an amplitude of the torque ripple compensation value based on the torque command value and a torque upper limit value set for the motor; and an amplitude adjustment unit that adjusts an amplitude of each frequency component in the torque ripple compensation value based on the ripple amplitude upper limit value and calculates an amplitude-adjusted torque ripple compensation value.

### TECHNICAL FIELD

The present invention relates to a device for controlling a motor.

### BACKGROUND ART

In a motor control device according to a related art, a motor current is controlled such that a torque generated by a motor follows a torque command. At this time, torque ripple that is torque vibration corresponding to a magnetic pole position of the motor occurs, which may cause vibration and noise. Therefore, a motor control method for reducing the torque ripple has been devised.

For example, PTL 1 is known as a control method for reducing vibration by suppressing torque ripple of a motor. A motor control device described in PTL 1 creates a table regarding an amplitude and a phase of the torque ripple corresponding to a torque generated by the motor, calculates a torque ripple compensation value based on a torque command value such that the amplitude and the phase of the torque ripple are suppressed by referring to the table, superimposes the torque ripple compensation value on the torque command value, and controls a current of the motor. Thus, the torque ripple of the motor is suppressed to reduce vibration.

Meanwhile, in order to protect a motor and an inverter, an upper limit value is generally set for an output current of the inverter, and in a case where a torque command value corresponding to the output current close to the upper limit value is given, an adjusted torque command value on which a torque ripple compensation value is superimposed is limited to a value at which the output current becomes equal to or less than the upper limit value. As a result, unintended torque ripple may occur or an average torque may decrease.

For example, PTL 2 is known as a method for preventing a decrease in average torque caused by a limitation of an adjusted torque command value on which a torque ripple compensation value is superimposed. In a case where a maximum vibration value obtained by adding an amplitude of a vibration torque command value to a basic torque command value is larger than an upper limit command value, a control device for a rotary electric machine described in PTL 2 reduces the amplitude of the vibration torque command value such that the maximum vibration value becomes equal to or smaller than the upper limit command value, and calculates a final torque command value. As a result, an average value of the final torque command value is prevented from becoming smaller than the basic torque command value.

### CITATION LIST

### Patent Literature

PTL 1: JP 5784787 B2
PTL 2: JP 6400231 B2

### SUMMARY OF INVENTION

### Technical Problem

PTL 1 and PTL 2 do not mention suppression of unintended torque ripple occurring due to a limitation of an output current.

In view of the above problem, a main object of the present invention is to effectively suppress torque ripple even in a case where a torque command value close to an upper limit value of an output current is given.

### Solution to Problem

A motor control device according to the present invention controls a motor based on a torque command value from a host controller, the motor control device including: a torque ripple compensation value computation unit that calculates a torque ripple compensation value for compensating for torque ripple occurring in the motor based on an electrical angular velocity of the motor and the torque command value; a ripple amplitude upper limit value calculating unit that calculates a ripple amplitude upper limit value which is an upper limit value for an amplitude of the torque ripple compensation value based on the torque command value and a torque upper limit value set for the motor; and an amplitude adjustment unit that adjusts an amplitude of each frequency component in the torque ripple compensation value based on the ripple amplitude upper limit value and calculates an amplitude-adjusted torque ripple compensation value, in which a final torque command value for controlling the motor is calculated based on the amplitude-adjusted torque ripple compensation value calculated by the amplitude adjustment unit and the torque command value.

### Advantageous Effects of Invention

According to the present invention, it is possible to effectively suppress torque ripple even in a case where a torque command value close to an upper limit value of an output current is given.

### BRIEF DESCRIPTION OF DRAWINGS

FIG. 1 is a schematic block diagram illustrating a configuration of a motor control device according to a first embodiment of the present invention.

FIG. 2 is a block diagram of a torque ripple compensation value computation unit according to the first embodiment of the present invention.

FIGS. 3A-3B are diagrams illustrating examples of a torque ripple estimation map.

FIGS. 4A-B are diagrams illustrating examples of a torque control response characteristic table.

FIG. 5 is a block diagram of a torque upper limit calculating unit and a ripple amplitude upper limit value calculating unit.

FIGS. 6A-6C are diagrams illustrating examples of a torque upper limit list.

FIG. 7 is a block diagram of an amplitude adjustment unit according to the first embodiment of the present invention.

FIG. 8 is a diagram illustrating an example of an amplitude reduction ratio map.

FIG. 9 is a block diagram of a current control unit.

FIG. 10 is a flowchart illustrating an example of a method of adjusting a torque ripple compensation value in the amplitude adjustment unit according to the first embodiment of the present invention.

FIGS. 11A-11C are explanatory diagrams illustrating outlines of an operation of the motor control device according to the first embodiment of the present invention.

FIGS. 12A-12B are comparative diagrams of torque ripple compensation amounts in a motor control device according to a related art and the motor control device according to the present invention.

FIG. 13 is a schematic block diagram illustrating a configuration of a motor control device according to a third embodiment of the present invention.

FIG. 14 is a block diagram of an amplitude adjustment unit according to the third embodiment of the present invention.

FIG. 15 is a flowchart illustrating an example of a method of adjusting a torque ripple compensation value in the amplitude adjustment unit according to the third embodiment of the present invention.

FIG. 16 is a schematic block diagram illustrating a configuration of a motor control device according to a fifth embodiment of the present invention.

FIG. 17 is a block diagram of a torque ripple compensation value computation unit according fifth embodiment of the present invention.

FIG. 18 is a flowchart illustrating an example of a method of adjusting a torque ripple compensation value in an amplitude adjustment unit according to the fifth embodiment of the present invention.

FIG. 19 is a flowchart illustrating an example of the method of adjusting the torque ripple compensation value in the amplitude adjustment unit according to the fifth embodiment of the present invention.

### DESCRIPTION OF EMBODIMENTS

### First Embodiment

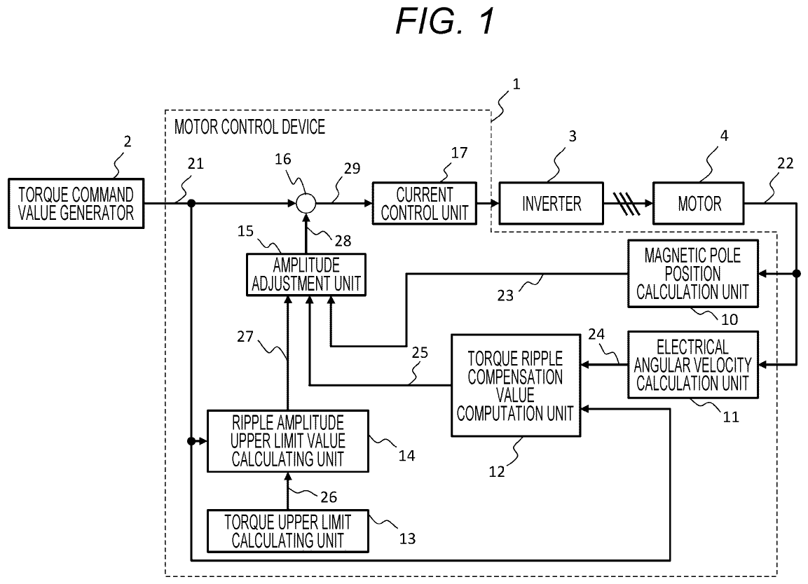

FIG. 1 is a schematic block diagram illustrating a configuration of a motor control device according to a first embodiment of the present invention. The motor control device 1 according to the present embodiment controls a motor 4 by controlling an operation of an inverter 3 based on a torque command value 21 from a torque command value generator 2 corresponding to a host controller. The motor control device 1 includes a magnetic pole position calculation unit 10, an electrical angular velocity calculation unit 11, a torque ripple compensation value computation unit 12, a torque upper limit calculating unit 13, a ripple amplitude upper limit value calculating unit 14, an amplitude adjustment unit 15, a torque command value correction unit 16, and a current control unit 17. The motor control device 1 is implemented by, for example, a microcomputer, and can implement these functional blocks by executing a predetermined program in the microcomputer. Alternatively, some or all of these functional blocks may be implemented using a hardware circuit such as a logic integrated circuit (IC) or a field programmable gate array (FPGA).

The magnetic pole position calculation unit 10 acquires sensor information 22 regarding a magnetic pole position of the motor 4, calculates the magnetic pole position of the motor 4 based on the sensor information 22, and outputs the calculation result to the amplitude adjustment unit 15 as a magnetic pole position 23. As the sensor information 22, for example, a signal output from a position sensor such as a resolver or a Hall sensor attached to the motor 4 can be used. Alternatively, position sensorless control in which a current and a voltage of the motor 4 are acquired as the sensor information 22 without using the position sensor, and the magnetic pole position of the motor 4 is calculated from the values may be applied. Further, the magnetic pole position 23 may be an electrical angle or a mechanical angle. In a case where the magnetic pole position 23 is the mechanical angle, the amplitude adjustment unit 15 can convert the mechanical angle into the electrical angle based on the number of pole pairs of the motor 4.

The electrical angular velocity calculation unit 11 acquires the sensor information 22 regarding the magnetic pole position of the motor 4, calculates an electrical angular velocity of the motor 4 based on the sensor information 22, and outputs the calculation result to the torque ripple compensation value computation unit 12 as an electrical angular velocity 24. The electrical angular velocity 24 may be output by calculating the electrical angular velocity of the motor 4 based on the magnetic pole position 23 output from the magnetic pole position calculation unit 10 instead of the sensor information 22.

The torque ripple compensation value computation unit 12 calculates a compensation value for compensating for torque ripple occurring in the motor 4 based on the torque command value 21 from the torque command value generator 2 and the electrical angular velocity 24 from the electrical angular velocity calculation unit 11. Then, the calculation result is output to the amplitude adjustment unit 15 as a torque ripple compensation value 25. A method of calculating the torque ripple compensation value 25 by the torque ripple compensation value computation unit 12 is described below.

The torque upper limit calculating unit 13 calculates an upper limit value of a torque corresponding to a state of the motor 4, and outputs a calculation result to the ripple amplitude upper limit value calculating unit 14 as a torque upper limit value 26. The torque upper limit calculating unit 13 selects a maximum torque having the smallest absolute value according to the current state of the motor 4 from among a plurality of maximum torques preset based on, for example, a result of preliminary calculation or an experiment, and outputs the value of the maximum torque as the torque upper limit value 26. Alternatively, a preset constant torque upper limit value 26 may be output.

The ripple amplitude upper limit value calculating unit 14 calculates an upper limit value for an amplitude of the torque ripple compensation value 25 output from the torque ripple compensation value computation unit 12 based on the torque command value 21 from the torque command value generator 2 and the torque upper limit value 26 from the torque upper limit calculating unit 13. Then, the calculation result is output to the amplitude adjustment unit 15 as a ripple amplitude upper limit value 27.

The amplitude adjustment unit 15 adjusts an amplitude of each frequency component in the torque ripple compensation value 25 based on the ripple amplitude upper limit value 27 from the ripple amplitude upper limit value calculating unit 14. An amplitude-adjusted torque ripple compensation value 28 is calculated and output to the torque command value correction unit 16 based on the torque ripple compensation value 25 whose amplitude has been adjusted for each frequency component and the magnetic pole position 23 from the magnetic pole position calculation unit 10. A method of calculating the amplitude-adjusted torque ripple compensation value 28 by the amplitude adjustment unit 15 is described below.

The torque command value correction unit 16 subtracts the amplitude-adjusted torque ripple compensation value 28 from the torque command value 21 to correct the torque command value 21. Then, the corrected torque command value 21 is output to the current control unit 17 as a final torque command value 29 for controlling the motor 4.

The current control unit 17 generates a control signal for the inverter 3 based on the final torque command value 29 output from the torque command value correction unit 16. For example, a gate signal for controlling an operation of a switching element such as an insulated gate bipolar transistor (IGBT) or a metal-oxide-semiconductor field effect transistor (MOSFET) provided in the inverter 3 is generated as the control signal for the inverter 3 and output to the inverter 3.

The inverter 3 operates based on the control signal from the current control unit 17, converts direct current (DC) power supplied from a DC power supply (not illustrated) into alternating current (AC) power, and supplies the AC power to the motor 4.

The motor 4 is driven using the AC power supplied from the inverter 3, and generates a torque corresponding to the final torque command value 29. For the motor 4, for example, a permanent magnet synchronous rotary electric machine is used. However, a structure of the motor 4 is not limited thereto as long as the motor exhibits torque ripple. For example, the present invention is applicable even in a case where a linear motor or an induction machine is used as the motor 4. The motor 4 may have a function of a generator in addition to a function of an electric motor.

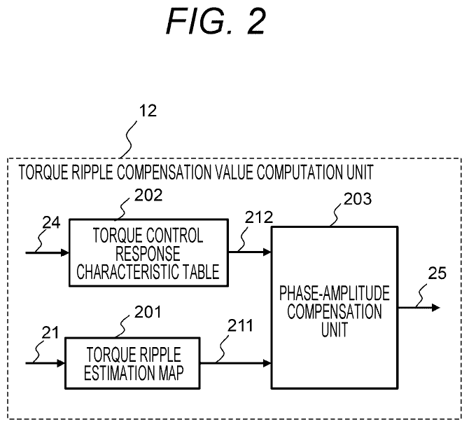

Next, details of the torque ripple compensation value computation unit 12 are described below with reference to FIGS. 2 to 4.

FIG. 2 is a block diagram of the torque ripple compensation value computation unit 12 according to the first embodiment of the present invention. The torque ripple compensation value computation unit 12 includes a torque ripple estimation map 201, a torque control response characteristic table 202, and a phase-amplitude compensation unit 203.

The torque ripple estimation map 201 holds a compensation coefficient of the torque ripple corresponding to the torque. The torque ripple compensation value computation unit 12 estimates an amplitude and a phase for each order n (n is a natural number) of the torque ripple occurring in the motor 4 by referring to the torque ripple estimation map 201 based on the torque command value 21 input from the torque command value generator 2. Then, an estimation result 211 for the amplitude and the phase of the torque ripple of each order is input to the phase-amplitude compensation unit 203.

In the present embodiment, the torque ripple estimation map 201 is, for example, a compensation coefficient map recorded for each order n of the torque ripple. In the compensation coefficient map, a torque value and values of an amplitude An and a phase on of the torque ripple for each order n are recorded in association with each other. Therefore, the torque ripple compensation value computation unit 12 can estimate the values of the amplitude An and the phase on of the torque ripple corresponding to the torque command value 21 for each order by referring to the torque ripple estimation map 201.

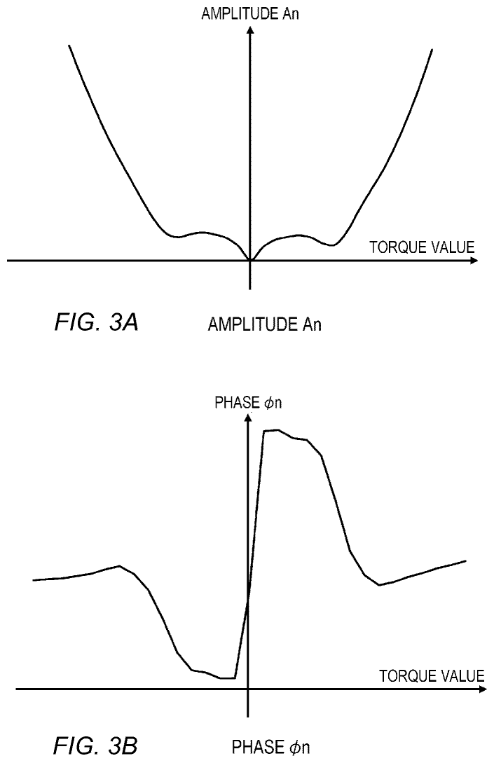

FIGS. 3A and 3B are diagrams illustrating an example of the torque ripple estimation map 201 for one order. FIG. 3A illustrates an example of the torque ripple estimation map 201 representing a relationship between the torque value and the amplitude An of the torque ripple, and FIG. 3B illustrates an example of the torque ripple estimation map 201 representing a relationship between the torque value and the phase on of the torque ripple.

As an overall tendency, as illustrated in FIG. 3(A), as the absolute value of the torque increases, the amplitude An of the torque ripple increases, but the amplitude An does not necessarily increase monotonically or decrease monotonically. On the other hand, as illustrated in FIG. 3B, a tendency of a change in the phase on of the torque ripple with respect to a change in the torque value is not constant. As described above, the amplitude An and the phase on of the torque ripple change according to the torque value.

In the present embodiment, the torque ripple compensation value computation unit 12 holds, as the torque ripple estimation map 201, a characteristic of the torque ripple obtained in advance from a result of an experiment, electromagnetic field analysis, or the like. Then, when the torque command value 21 is input from the torque command value generator 2, the amplitude An and the phase on of the torque ripple corresponding to the torque value represented by the torque command value 21 are acquired by referring to the torque ripple estimation map 201. At this time, in a case where the amplitude An and the phase on corresponding to the torque command value 21 are not recorded in the torque ripple estimation map 201, the amplitude An and the phase on corresponding to the torque command value 21 may be acquired by interpolation or extrapolation. As a result, the torque ripple corresponding to the torque command value 21 can be estimated using the torque ripple estimation map 201 in which the amplitude An and the phase on are recorded in advance in association with each other for each order n of the torque ripple, and the estimation result 211 can be obtained.

In a case where a shape of the torque ripple occurring in the motor 4 changes with respect to the same torque value due to a change in a condition such as a temperature, the torque ripple compensation value computation unit 12 may hold a plurality of torque ripple estimation maps 201 set for each condition and use the torque ripple estimation maps 201 according to the condition.

In addition, the torque ripple compensation value computation unit 12 may hold the torque ripple estimation map 201 by using a numerical value such as a complex number or a coefficient of an approximation function instead of a graph form as illustrated in FIG. 3. For example, the amplitude An and the phase on of the torque ripple can be expressed using a complex coefficient as in the following Formula (1). In this case, the phase-amplitude compensation unit 203 can easily process the estimation result 211 obtained from the torque ripple estimation map 201 as a multiplication of a single coefficient. In addition, the value of the phase on can be easily optimized in an interpolation operation or extrapolation operation by using the complex coefficient. On the other hand, in a case where the torque ripple estimation map 201 is held as the coefficient of the approximation function, a volume of data can be reduced. In addition, the interpolation operation or extrapolation operation can be continuously performed by calculation of the function.

$$[ Formula 1 ]$$

$${Z}_{n} = {A}_{n} {e}^{j {ϕ}_{n}} \qquad ( Formula 1 )$$

The torque control response characteristic table 202 holds, for each electrical angular frequency, values of an amplitude compensation amount Gn and a phase compensation amount On necessary for canceling a phase delay and an amplitude change caused by a torque control system. The torque ripple compensation value computation unit 12 multiplies the electrical angular velocity 24 input from the electrical angular velocity calculation unit 11 by the order n of the torque ripple and calculates a reciprocal thereof to obtain the electrical angular frequency for each order. Then, the amplitude compensation amount Gn and the phase compensation amount On are obtained for each order n of the torque ripple occurring in the motor 4 by referring to the torque control response characteristic table 202 based on the obtained electrical angular frequency, and the calculation results are input to the phase-amplitude compensation unit 203 as amplitude and phase compensation amounts 212.

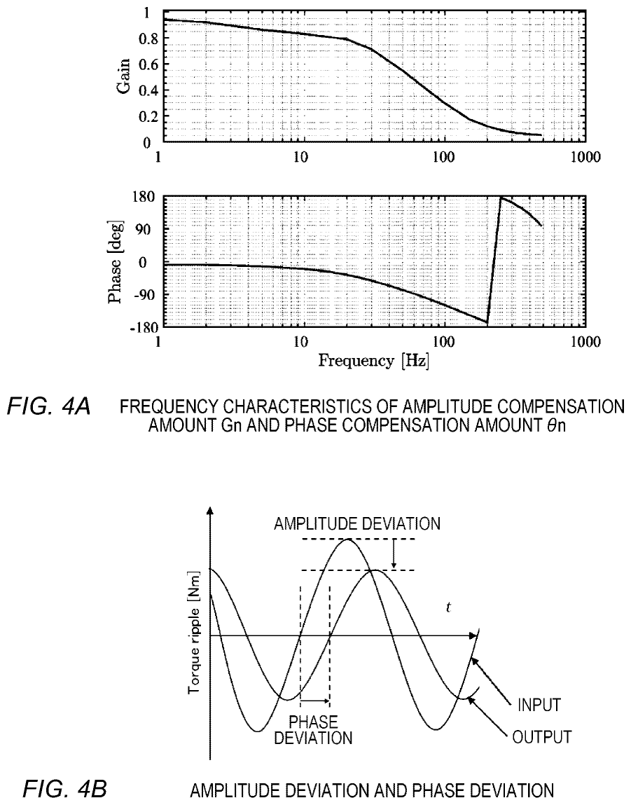

FIGS. 4A and 4B are diagrams illustrating an example of the torque control response characteristic table 202. FIG. 4A illustrates an example of frequency characteristics of the amplitude compensation amount Gn and the phase compensation amount On, and FIG. 4B illustrates an example of an amplitude deviation and a phase deviation in the time domain, corresponding to the amplitude compensation amount Gn and the phase compensation amount On. In FIG. 4(A), a gain value represented by the vertical axis in the upper diagram indicates a ratio (amplitude deviation) of an amplitude of an output torque with respect to an amplitude of the torque command value 21. In addition, a phase value represented by the vertical axis of the lower diagram indicates a phase delay (phase deviation) of the output torque with respect to the torque command value 21. FIG. —4(B) illustrates the amplitude deviation and the phase deviation of the output torque with respect to the torque command value 21 in the time domain.

As can be seen from FIGS. 4(A) and 4(B), the output torque of the motor 4 deviates from the torque command value 21. In order to cancel the deviations, for example, it is sufficient if the amplitude An is multiplied by a reciprocal of the gain value corresponding to the electrical angular frequency corresponding to each order n, and the phase value corresponding to the electrical angular frequency corresponding to each order n is subtracted from the phase on based on the estimation result 211 for the amplitude An and the phase on obtained for each order n of the torque ripple from the torque ripple estimation map 201. At this time, the amplitude compensation amount Gn corresponds to the reciprocal of the gain value obtained from the upper diagram of FIG. 4(A), and the phase compensation amount On corresponds to the phase value obtained from the lower diagram of FIG. 4(A).

In the present embodiment, the torque ripple compensation value computation unit 12 holds, as the torque control response characteristic table 202, frequency characteristics of the amplitude deviation and the phase deviation of the output torque with respect to the torque command value 21 obtained in advance as a result of an experiment, electromagnetic field analysis, or the like. Then, when the electrical angular velocity 24 is input from the electrical angular velocity calculation unit 11, the electrical angular frequency for each order n is obtained based on the electrical angular velocity 24, and the amplitude compensation amount Gn and the phase compensation amount On corresponding to the electrical angular frequency for each order n are acquired by referring to the torque control response characteristic table 202. As a result, the amplitude and phase compensation amounts 212 corresponding to the electrical angular velocity 24 can be calculated for each order n of the torque ripple by using the torque control response characteristic table 202 representing the frequency characteristics of amplitude compensation amount Gn and the phase compensation amount On.

In a case where a torque control response characteristic changes according to the change in a control condition such as a carrier frequency or a control gain, a plurality of torque control response characteristic tables 202 set for each control condition may be held in the torque ripple compensation value computation unit 12, and the torque control response characteristic table 202 may be selectively used according to the control condition.

In the torque control response characteristic table 202, in a region where the electrical angular frequency is equal to or higher than a certain value, the frequency characteristic of the phase compensation amount On may be set such that the value of the amplitude compensation amount Gn decreases as the electrical angular frequency increases and the amplitude compensation amount Gn gradually becomes 0. By doing so, the torque ripple compensation value computation unit 12 can calculate the torque ripple compensation value 25 such that the amplitude of the torque ripple compensation value 25 decreases as the electrical angular velocity 24 increases in a case where the electrical angular velocity 24 is equal to or higher than a predetermined reference value. As a result, when the motor 4 rotates at a high speed, a torque ripple suppression operation by the motor control device 1 can be smoothly stopped. As a result, an influence of the torque ripple becomes relatively small, and calculation resources of the motor control device 1 can be intensively allocated to processing by the current control unit 17 at the time of high-speed rotation of the motor 4 in which a time per electrical angle cycle is shortened, so that a processing load of the entire motor control device 1 can be optimized.

The phase deviation and the amplitude deviation in the torque control system represented by the torque control response characteristic table 202 includes response characteristics for a time delay in a sampling hold circuit that detects a current flowing through the motor 4, a computation delay for the torque command value 21, a delay in current control in the current control unit 17, and the like. The response characteristics for the respective factors may be collectively held as one torque control response characteristic table 202, or the torque control response characteristic table 202 may be divided and held for each factor. In a case where the torque control response characteristic table 202 is individually held for each factor, the amplitude compensation amount Gn and the phase compensation amount On obtained in each table are combined according to whether each factor is a series element or a parallel element on a control configuration.

The phase-amplitude compensation unit 203 obtains an amplitude compensation value An′ and a phase compensation value on′ for the torque ripple for each order based on the estimation result 211 for the amplitude and the phase of the torque ripple for each order obtained from the torque ripple estimation map 201 and the amplitude and phase compensation amounts 212 obtained from the torque control response characteristic table 202. Then, the obtained amplitude compensation value An′ and phase compensation value φn′ are output to the amplitude adjustment unit 15 as the torque ripple compensation value 25.

The torque ripple compensation value computation unit 12 calculates the torque ripple compensation value 25 based on the torque command value 21 and the electrical angular velocity 24 as described above.

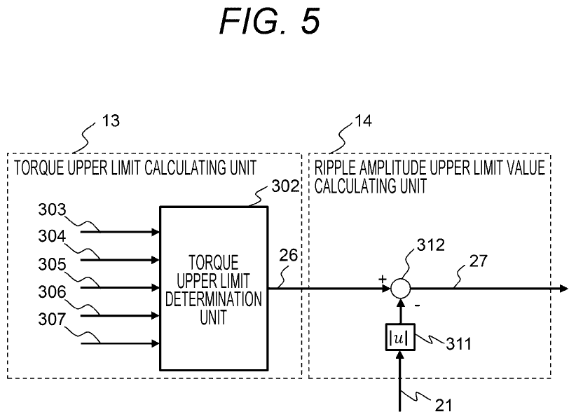

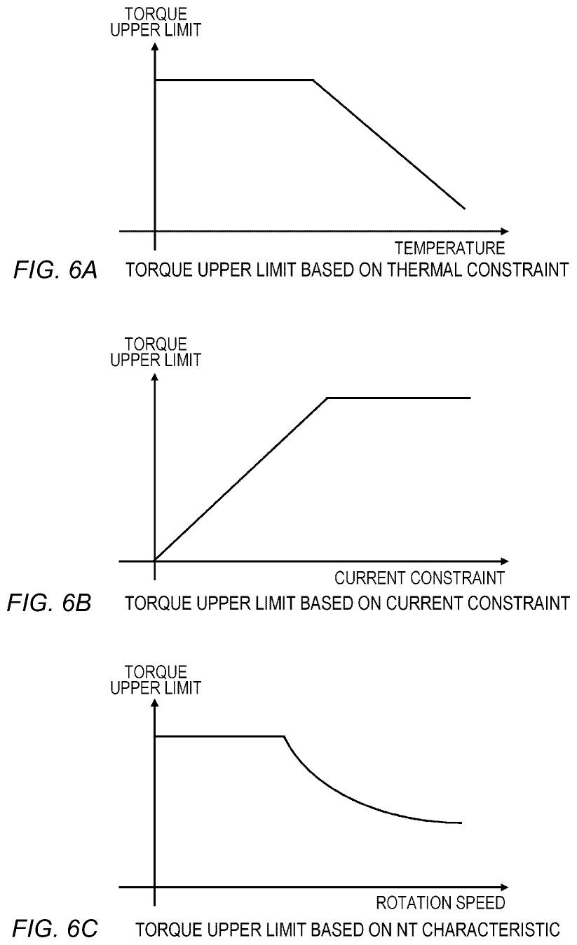

Next, details of the torque upper limit calculating unit 13 and the ripple amplitude upper limit value calculating unit 14 are described below with reference to FIGS. 5 and 6.

FIG. 5 is a block diagram of the torque upper limit calculating unit 13 and the ripple amplitude upper limit value calculating unit 14. The torque upper limit calculating unit 13 includes a torque upper limit determination unit 302, and the ripple amplitude upper limit value calculating unit 14 includes an absolute value calculation unit 311 and a subtractor 312.

Torque upper limit lists 303 to 307 are input to the torque upper limit determination unit 302. The torque upper limit lists 303 to 307 are lists of maximum torques preset based on a result of preliminary calculation or an experiment, and are set according to different conditions. For example, the torque upper limit list 303 given by an arbitrary value, the torque upper limit list 304 representing a search upper limit of a map for converting the torque command value 21 into a current command value, the torque upper limit list 305 calculated based on a thermal constraint of the inverter 3 or the motor 4, the torque upper limit list 306 calculated based on a current constraint of the inverter 3 or the motor 4, the torque upper limit list 307 set based on an NT characteristic between a rotation speed of the motor 4 and the output torque, and the like are input to the torque upper limit determination unit 302. The torque upper limit list 303 and the torque upper limit list 304 may be given as constants.

FIGS. 6A-6C are diagrams illustrating an example of the torque upper limit list. As illustrated in FIG. 6A, for example, the torque upper limit list 305 based on the thermal constraint is set such that the torque upper limit value decreases as the temperature increases at a certain temperature or higher. The temperature represented by the horizontal axis in FIG. 6A represents, for example, a temperature monitored by a temperature sensor installed in the inverter 3 or the motor 4. In general, the torque upper limit list 305 is used to increase the torque upper limit value in a low temperature region and to restrict the torque upper limit value such that demagnetization of a magnet does not occur in a high temperature region.

For example, as illustrated in FIG. 6B, the torque upper limit list 306 based on the current constraint is set such that the torque upper limit value decreases as the current decreases at a current equal to or lower than a certain value. The current constraint represented by the horizontal axis in FIG. 6B represents, for example, a current monitored by a current sensor installed between the inverter 3 and the motor 4. The torque upper limit list 306 is used to determine the torque upper limit given in correspondence with a current constraint of a circuit in the inverter 3 or the motor 4. The current constraint is provided to suppress a current resistance of an electric wire and temperature rise, and changes according to an operation status of the motor 4.

As illustrated in FIG. 6C, for example, the torque upper limit list 307 based on the NT characteristic of the motor 4 is set such that the torque upper limit value decreases as the rotation speed increases at a motor rotation speed equal to or higher than a certain value. The torque upper limit list 307 is used to restrict the output torque of the motor 4 due to a voltage constraint at a motor rotation speed equal to or higher than a certain value.

The torque upper limit lists 305 to 307 illustrated in FIGS. 6A-6C are examples, and another torque upper limit list may be set. The torque upper limit calculating unit 13 can input arbitrary torque upper limit lists 303 to 307 including the above-described torque upper limit lists 303 and 304 to the torque upper limit determination unit 302. In addition, the torque upper limit value input to the torque upper limit determination unit 302 is not limited to the torque upper limit lists 303 to 307, and may be arbitrarily added or deleted.

The torque upper limit determination unit 302 obtains the torque upper limit values according to an operation condition of the motor 4 for the input torque upper limit lists 303 to 307, and outputs the torque upper limit value having the smallest absolute value among the torque upper limit values to the ripple amplitude upper limit value calculating unit 14 as the final torque upper limit value 26.

The absolute value calculation unit 311 calculates an absolute value of the torque command value 21 input from the torque command value generator 2, and outputs the absolute value to the subtractor 312. The subtractor 312 calculates a difference between the torque upper limit value 26 output from the torque upper limit determination unit 302 and the absolute value of the torque command value 21 output from the subtractor 312, and outputs the calculation result to the amplitude adjustment unit 15 as the ripple amplitude upper limit value 27.

As described above, the ripple amplitude upper limit value calculating unit 14 can calculate the ripple amplitude upper limit value 27, which is an upper limit value for the amplitude of the torque ripple compensation value 25, based on the torque command value 21 and the torque upper limit value preset in the torque upper limit calculating unit 13.

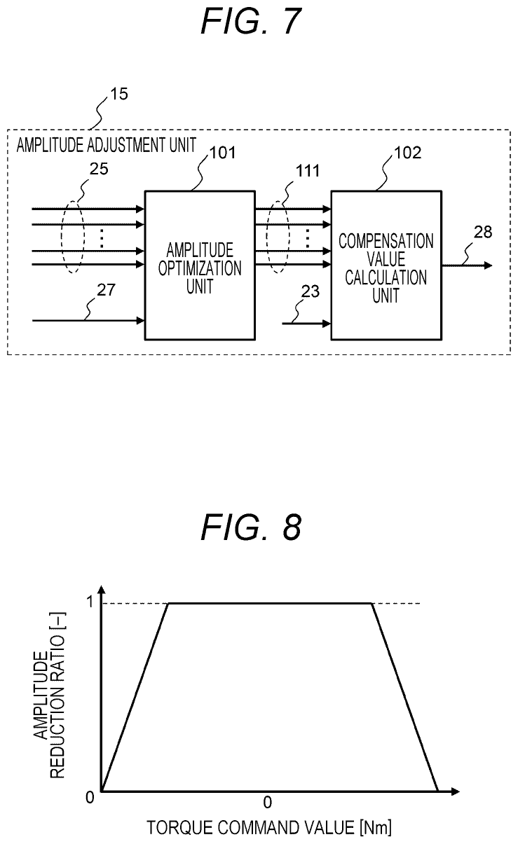

Next, details of the amplitude adjustment unit 15 are described below with reference to FIGS. 7 and 8.

FIG. 7 is a block diagram of the amplitude adjustment unit 15 according to the first embodiment of the present invention. The amplitude adjustment unit 15 includes an amplitude optimization unit 101 and a compensation value calculation unit 102.

The amplitude optimization unit 101 adjusts the amplitude of the torque ripple compensation value 25 for each order n output from the torque ripple compensation value computation unit 12, that is, the amplitude of each frequency component in the torque ripple compensation value 25, based on the ripple amplitude upper limit value 27 output from the ripple amplitude upper limit value calculating unit 14. For example, the amplitude optimization unit 101 adjusts the amplitude compensation value An′ for each order n such that, among the amplitude compensation value An′ and the phase compensation value φn′ obtained by the phase-amplitude compensation unit 203 of the torque ripple compensation value computation unit 12, the amplitude compensation value An′ is equal to or less than the ripple amplitude upper limit value 27, and obtains an adjusted amplitude compensation value Ana.

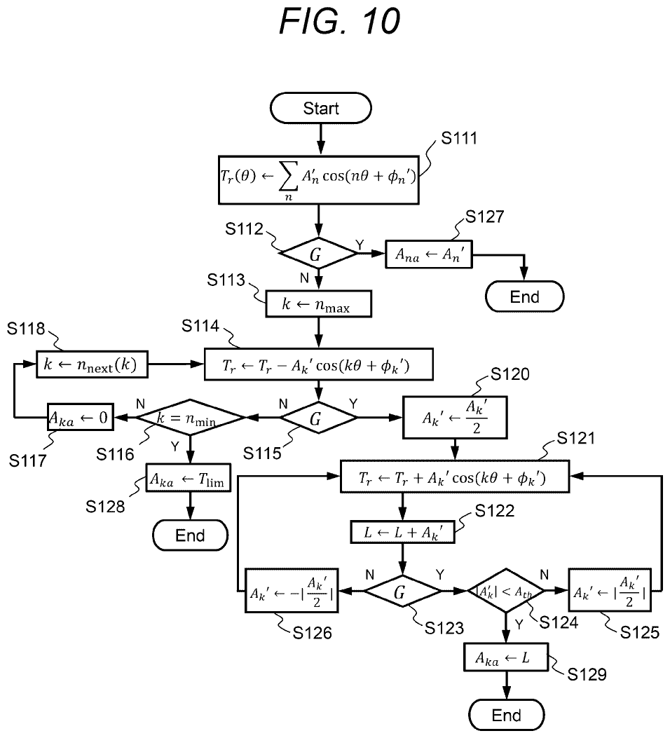

Specifically, for example, the amplitude optimization unit 101 calculates a maximum amplitude of the torque ripple compensation value 25 by superimposing the amplitude compensation value An′ and the phase compensation value φn′ calculated for each order n in the phase-amplitude compensation unit 203. Then, the calculated maximum amplitude is compared with the ripple amplitude upper limit value 27, an order that is a target of amplitude limitation (amplitude-limiting order) is determined in a predetermined order until the maximum amplitude becomes equal to or lower than the ripple amplitude upper limit value 27, and the amplitude compensation value An′ of the amplitude-limiting order is adjusted to be small. As a result, when the maximum amplitude becomes equal to or lower than the ripple amplitude upper limit value 27, the adjusted amplitude compensation value Ana and an adjusted phase compensation value φna for each order n at this time are output to the compensation value calculation unit 102 as adjusted phase-amplitude information 111. Details of a method of adjusting the amplitude compensation value An′ in the amplitude optimization unit 101 are described below with reference to the flowchart illustrated in FIG. 10.

The amplitude optimization unit 101 can arbitrarily change an objective function and a constraint condition used when the amplitude of the torque ripple compensation value 25 is adjusted for each order n according to the purpose of torque ripple suppression. An optimization method for adjusting the amplitude of the torque ripple compensation value 25 is not limited to the above method, and any method can be adopted. In addition, the adjusted amplitude compensation value Ana for each order n may be calculated in advance for each combination of the torque ripple compensation value 25 and the ripple amplitude upper limit value 27, and the calculated value may be stored in the amplitude optimization unit 101, whereby the adjusted phase-amplitude information 111 may be output by referring to the calculated value. In this way, a calculation load of the amplitude adjustment unit 15 can be reduced.

FIG. 8 is a diagram illustrating an example of an amplitude reduction ratio map used when the amplitude compensation value An′ is adjusted in the amplitude optimization unit 101. In FIG. 8, the horizontal axis represents the torque command value 21, and the vertical axis represents a reduction ratio of the amplitude compensation value An′ before and after the adjustment. The amplitude optimization unit 101 holds, for example, the amplitude reduction ratio map as illustrated in FIG. 8 for each order n and and each condition, can determine the adjusted amplitude compensation value Ana from the amplitude compensation value An′ based on the amplitude reduction ratio map.

The compensation value calculation unit 102 calculates an amplitude-adjusted torque ripple compensation value 28 based on the adjusted phase-amplitude information 111 output from the amplitude optimization unit 101 and the magnetic pole position 23. For example, the compensation values for the amplitude and the phase corresponding to the magnetic pole position 23 are obtained for each order n based on the adjusted amplitude compensation value Ana and the adjusted phase compensation value φna for each order n (each amplitude-limiting order and each of other orders). As a result, the compensation value calculation unit 102 can calculate the amplitude-adjusted torque ripple compensation value 28. The compensation value calculation unit 102 outputs the thus-obtained amplitude-adjusted torque ripple compensation value 28 to the torque command value correction unit 16.

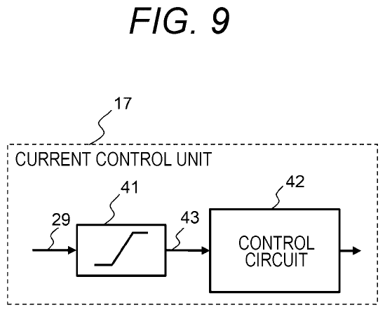

Next, details of the current control unit 17 are described below with reference to FIG. 9.

FIG. 9 is a block diagram of the current control unit 17. The current control unit 17 includes a limit processing unit 41 and a control circuit 42.

The limit processing unit 41 compares the final torque command value 29 output from the torque command value correction unit 16 based on the torque command value 21 and the amplitude-adjusted torque ripple compensation value 28 with a predetermined limit value. As a result, in a case where the final torque command value 29 exceeds the limit value, the final torque command value 29 is replaced with the limit value to limit the final torque command value 29, and the limit value is output to the control circuit 42 as a final torque command value 43 after the limit processing. In a case where the final torque command value 29 is equal to or smaller than the limit value, the final torque command value 29 may be output as the final torque command value 43 after the limit processing as it is.

The control circuit 42 generates the control signal for the inverter 3 by performing predetermined current control computation based on the final torque command value 43 after the limit processing output from the limit processing unit 41.

As long as the control signal for the inverter 3 can be generated based on the final torque command value 29, a configuration of the current control unit 17 is not limited to that illustrated in FIG. 9. For example, the current control unit 17 may be implemented using only the control circuit 42 without providing the limit processing unit 41.

Next, a detailed operation of the motor control device 1 according to the present embodiment and effects thereof are described below.

The motor control device 1 estimates the amplitude An and the phase on for each order n of the torque ripple by referring to the torque ripple estimation map 201 based on the torque command value 21 in the torque ripple compensation value computation unit 12. The amplitude compensation amount Gn and the phase compensation amount On are obtained for each order n of the torque ripple by referring to the torque control response characteristic table 202 based on the electrical angular velocity 24 of the motor 4. Then, the amplitude compensation value An′ and the phase compensation value φn′ for the torque ripple are obtained for each order n based on these values by the following Formula (2).

$$[ Formula 2 ]$$

$${A}_{n}^{′} = {A}_{n} {G}_{n} \qquad ( Formula 2 )$$

$${ϕ}_{n}^{′} = {ϕ}_{n} - {θ}_{n}$$

The torque upper limit calculating unit 13 calculates a torque upper limit value Tmax corresponding to the operation condition of the motor 4. The ripple amplitude upper limit value calculating unit 14 calculates a ripple amplitude upper limit value Tlim from the torque upper limit value Tmax and a torque command value Tc by the following Formula (3). The torque command value Tc corresponds to the torque command value 21, the torque upper limit value Tmax corresponds to the torque upper limit value 26, and the ripple amplitude upper limit value Tlim corresponds to the ripple amplitude upper limit value 27.

$$[ Formula 3 ]$$

$${T}_{lim} = {T}_{max} - \vert {T}_{c} \vert \qquad ( Formula 3 )$$

The amplitude adjustment unit 15 calculates an amplitude-adjusted torque ripple compensation value Tr based on the amplitude compensation value An′ and the phase compensation value φn′ calculated by the torque ripple compensation value computation unit 12 and the ripple amplitude upper limit value Tlim calculated by the ripple amplitude upper limit value calculating unit 14. Here, the adjusted amplitude compensation value Ana and the adjusted phase compensation value φna with respect to the amplitude compensation value An′ and the phase compensation value φn′ represented by the torque ripple compensation value 25 are obtained based on the ripple amplitude upper limit value Tlim represented by the ripple amplitude upper limit value 27, and the amplitude-adjusted torque ripple compensation value Tr is calculated from these values. A specific method of calculating the amplitude-adjusted torque ripple compensation value Tr by the amplitude adjustment unit 15 is described below.

The torque command value correction unit 16 subtracts, from the torque command value Tc, the amplitude-adjusted torque ripple compensation value Tr calculated by the amplitude adjustment unit 15 to calculate a final torque command value Tcr.

The current control unit 17 generates the control signal for the inverter 3 by using the final torque command value Tcr calculated by the torque command value correction unit 16. Then, the generated control signal is output to the inverter 3 to control the operation of the inverter 3, thereby performing drive control of the motor 4.

FIG. 10 is a flowchart illustrating an example of a method of adjusting the torque ripple compensation value 25 in the amplitude adjustment unit 15 according to the first embodiment of the present invention. The flowchart of FIG. 10 illustrates a flow of processing in a case where the amplitude optimization unit 101 of the amplitude adjustment unit 15 adjusts the torque ripple compensation value 25 by using a two-stage amplitude adjustment algorithm using binary search.

First, in step S111, based on the amplitude compensation value An′ and the phase compensation value φn′ represented by the torque ripple compensation value 25 output from the phase-amplitude compensation unit 203 of the torque ripple compensation value computation unit 12, a torque ripple function Tr(θ) is defined by the following Formula (4).

$$[ Formula 4 ]$$

$${T}_{r} ( θ ) = {\sum }_{n} {A}_{n}^{′} = cos ( n θ + {ϕ}_{n}^{′} ) \qquad ( Formula 4 )$$

Next, in step S112, whether or not a maximum value or a minimum value of the torque ripple compensation value 25 exceeds the ripple amplitude upper limit value Tlim is evaluated by an evaluation formula G defined by the following Formula (5) using the torque ripple function Tr(θ). In Formula (5), nm represents a minimum order among the orders n, and θnow represents the current magnetic pole position.

$$[ Formula 5 ]$$

$$\begin{matrix}When Tc \geq 0 & G : {max}_{θ ∈ [ {θ}_{now} , {θ}_{now} + 2 π / {π}_{m} ]} & {T}_{r} \leq {T}_{lim}\end{matrix} \qquad ( Formula 5 )$$

$$When Tc \leq 0 \qquad G : {min}_{θ ∈ [ {θ}_{now} , {θ}_{now} + 2 π / {π}_{m} ]} \qquad {T}_{r} \geq - {T}_{lim}$$

In a case where the evaluation result in step S112 is true (S112: Y), that is, in a case where the evaluation formula G is satisfied, it is determined that the amplitude compensation value An′ does not need to be adjusted, and the processing proceeds to step S127. In step S127, the amplitude compensation value An′ is set as the adjusted amplitude compensation value Ana for all the orders n of the torque ripple, and the processing illustrated in the flowchart of FIG. 10 ends.

On the other hand, in a case where the evaluation result in step S112 is false (S112: N), that is, in a case where the evaluation formula G is not satisfied, it is determined that the amplitude compensation value An′ needs to be adjusted according to a predetermined order, and the processing proceeds to step S113. In the present embodiment, in order to preferentially suppress a lower-order torque ripple component, the amplitude-limiting order is determined sequentially from higher to lower orders, with the lowest order assigned last. In general, a lower-order component of the torque ripple of the motor is larger, and thus, a greater torque ripple suppression effect can be obtained by preferentially suppressing the lower-order torque ripple.

In step S113, nmax is substituted into a variable k. nmax represents a maximum order handled in the motor control device 1 among the orders n of the torque ripple. In subsequent step S114, Ak′cos (kθ+φk′) corresponding to a torque ripple component corresponding to a current value of the variable k is subtracted from the torque ripple function Tr(θ), and the torque ripple function Tr(θ) in a case where the amplitude is reduced with an order of the torque ripple component as the amplitude-limiting order is newly defined. In the torque ripple component, Ak′ and pk′ represent an amplitude compensation value and a phase compensation value of the component according to the current value of the variable k, respectively.

In step S115, whether or not the maximum value or the minimum value of the torque ripple compensation value 25 exceeds the ripple amplitude upper limit value Tlim is evaluated in a case where the amplitude for the order corresponding to the current value of the variable k is reduced with the order as the amplitude-limiting order by the evaluation formula G defined by the above Formula (5) using the torque ripple function Tr(θ) newly defined in step S114. In a case where the evaluation result in step S115 is true (S115: Y), that is, in a case where the evaluation formula G is satisfied, the processing proceeds to step S120. On the other hand, in a case where the evaluation result in step S115 is false (S115: N), that is, in a case where the evaluation formula G is not satisfied, the processing proceeds to step S116.

In step S116, it is determined whether or not the current value of the variable k is the minimum order nmin handled in the motor control device 1. In a case where k=nmin (S116: Y), the processing proceeds to step S128. In step S128, an adjusted amplitude compensation value Aka for the order corresponding to the current value (k=nmin) of the variable k is set to the ripple amplitude upper limit value Tlim, and the adjusted amplitude compensation values Ana (n≠k) for the other orders are all set to 0, and the processing illustrated in the flowchart of FIG. 10 ends.

On the other hand, in a case where k≠nmin (S116: N), the processing proceeds to step S117. In step S117, the adjusted amplitude compensation value Aka for the order corresponding to the current value of the variable k is set to 0. In subsequent step S118, the second lowest order nnext(k) following the order represented by the current value of the variable k is set as a new value of the variable k. After completion of step S118, the processing returns to step S114, and the same operation is repeated thereafter.

In step S120, a half value of the amplitude compensation value Ak′ for the order corresponding to the current value of the variable k is set as a new amplitude compensation value Ak′. At this time, a variable L is initialized to 0. In subsequent step S121, Ak′cos (kθ+φk′) corresponding to the torque ripple component corresponding to the current value of the variable k is added to the torque ripple function Tr(θ), and the torque ripple function Tr(θ) including the torque ripple component is newly defined.

In step S122, the amplitude compensation value Ak′ set in step S120 is added to the variable L. In subsequent step S123, whether or not the maximum value or the minimum value of the torque ripple compensation value 25 exceeds the ripple amplitude upper limit value Tlim is evaluated by the evaluation formula G defined by the above Formula (5) using the torque ripple function Tr(θ) newly defined in step S121. In a case where the evaluation result in step S123 is true (S123: Y), that is, in a case where the evaluation formula G is satisfied, the processing proceeds to step S124. On the other hand, in a case where the evaluation result in step S123 is false (S123: N), that is, in a case where the evaluation formula G is not satisfied, the processing proceeds to step S126.

In step S124, an absolute value of the amplitude compensation value Ak′ set in step S120 is compared with a threshold value Ath preset as an end condition of the binary search, and it is determined whether or not the absolute value | Ak′| of the amplitude compensation value Ak′ is smaller than the threshold value Ath. In a case where |Ak′|<Ath (S124: Y), the processing proceeds to step S129. In step S129, the adjusted amplitude compensation value Aka for the order corresponding to the current value of the variable k is set to a current value of the variable L, and the processing illustrated in the flowchart of FIG. 10 ends.

On the other hand, in a case where |Ak′|≥Ath (S124: N), the processing proceeds to step S125. In step S125, an absolute value of a half value of the amplitude compensation value Ak′ for the order corresponding to the current value of the variable k is set as a new amplitude compensation value Ak′. After completion of step S125, the processing returns to step S121, and the same operation is repeated thereafter.

In step S126, a value obtained by adding a minus sign to the absolute value of the half value of the amplitude compensation value Ak′ for the order corresponding to the current value of the variable k is set as a new amplitude compensation value Ak′. After completion of step S126, the processing returns to step S121, and the same operation is repeated thereafter.

The amplitude optimization unit 101 determines the adjusted amplitude compensation value Ana and the phase compensation value φna corresponding to the adjusted amplitude compensation value Ana for each order n of the torque ripple by repeatedly performing the processing illustrated in the flowchart of FIG. 10 described above until any end condition of steps S112, S116, and S124 is satisfied.

The compensation value calculation unit 102 calculates an amplitude-adjusted torque ripple compensation value Tr(θnow) corresponding to the magnetic pole position θnow based on the amplitude compensation value Ana and the phase compensation value φna represented by the adjusted phase-amplitude information 111 output from the amplitude optimization unit 101 and the current magnetic pole position θnow represented by the magnetic pole position 23 by the following Formula (6).

$$[ Formula 6 ]$$

$${T}_{r} ( {θ}_{now} ) = {\sum }_{n} {A}_{na} cos ( n {θ}_{now} + {ϕ}_{na} ) \qquad ( Formula 6 )$$

The torque ripple compensation value Tr(θnow) represented by the amplitude-adjusted torque ripple compensation value 28 output from the compensation value calculation unit 102 is input to the torque command value correction unit 16. The torque command value correction unit 16 calculates the final torque command value Tcr by the following Formula (7) based on the torque command value Tc represented by the torque command value 21 and the torque compensation value Tr represented by the amplitude-adjusted torque ripple compensation value 28.

$$[ Formula 7 ]$$

$${T}_{cr} = {T}_{c} - {T}_{r} \qquad ( Formula 7 )$$

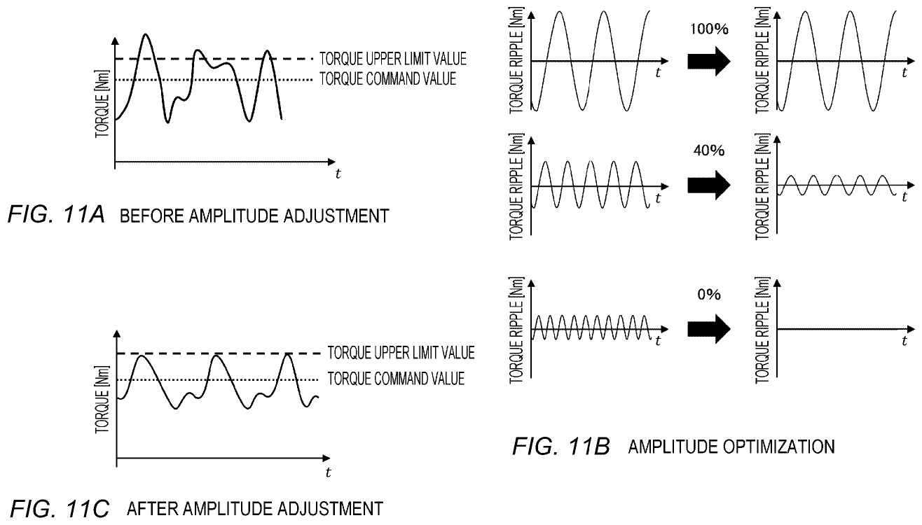

FIGS. 11A-11C are explanatory diagrams illustrating an outline of the operation of the motor control device according to the first embodiment of the present invention. In a state before the amplitude adjustment in which the amplitude of the torque ripple compensation value is not adjusted for each order n in the amplitude adjustment unit 15, a waveform of the torque output from the motor 4 according to the torque command value 21 from the torque command value generator 2 may exceed the torque upper limit value allowed in the motor 4, for example, as illustrated in FIG. 11A.

In the present embodiment, for example, as illustrated in FIG. 11B, the amplitude adjustment unit 15 adjusts the amplitude of the torque ripple compensation value for each order n corresponding to the torque command value such that a compensation value for a higher-order torque ripple component decreases first, thereby optimizing the amplitude. As a result, the waveform of the torque output from the motor 4 is suppressed to be equal to or less than the torque upper limit value allowed in the motor 4, for example, as illustrated in FIG. 11C.

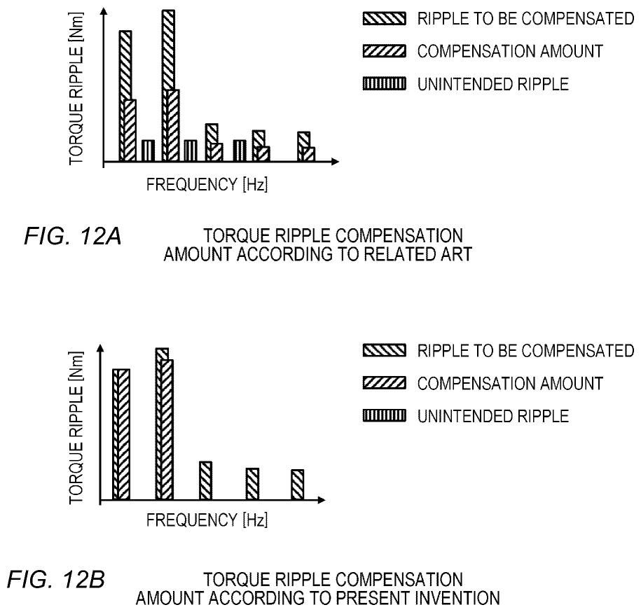

FIGS. 12A and 12B are comparative diagrams of torque ripple compensation amounts in a motor control device according to a related art and the motor control device according to the present invention. In the motor control device according to the related art, for example, for a torque ripple compensation value set according to a torque command value, an excess of a torque upper limit value is limited for each order n as illustrated in FIG. 12A. Therefore, unintended ripple and insufficiency of the compensation amount occur. On the other hand, in the motor control device according to the present invention, as described above, the amplitude adjustment unit 15 adjusts the amplitude of the torque ripple compensation value for each order n corresponding to the torque command value such that a compensation value for a higher-order torque ripple component decreases first, thereby optimizing the amplitude. As a result, for example, as illustrated in FIG. 12B, a compensation amount for a lower-order torque ripple component is maximized, and the torque ripple occurring in the motor 4 can be effectively suppressed. In FIGS. 12A and 12B, positions of bars of ripples to be compensated and compensation amounts are shifted from each other in a horizontal axis direction for ease of viewing, but in practice, the bars represent the same frequency.

According to the first embodiment of the present invention described above, the following effects are exhibited.

(1) The motor control device 1 controls the motor 4 based on the torque command value 21 from the torque command value generator 2 that is the host controller. The motor control device 1 includes the torque ripple compensation value computation unit 12 that calculates the torque ripple compensation value 25 for compensating for the torque ripple occurring in the motor 4 based on the electrical angular velocity 24 of the motor 4 and the torque command value 21, the ripple amplitude upper limit value calculating unit 14 that calculates the ripple amplitude upper limit value 27 which is an upper limit value for the amplitude of the torque ripple compensation value 25 based on the torque command value 21 and the torque upper limit value 26 set for the motor 4, and the amplitude adjustment unit 15 that adjusts the amplitude of each frequency component in the torque ripple compensation value 25 based on the ripple amplitude upper limit value 27 and calculates the amplitude-adjusted torque ripple compensation value 28. The motor control device 1 calculates the final torque command value 29 for controlling the motor 4 based on the amplitude-adjusted torque ripple compensation value 28 calculated by the amplitude adjustment unit 15 and the torque command value 21. With such a configuration, it is possible to effectively suppress torque ripple even in a case where the torque command value 21 close to the upper limit value of the output current is given.

(2) The torque ripple compensation value computation unit 12 estimates the torque ripple corresponding to the torque command value 21 by using the torque ripple estimation map 201 in which the amplitude and the phase are recorded in advance in association with each other for each order of the torque ripple. With such a configuration, it is possible to easily and reliably estimate the torque ripple for each order corresponding to the torque command value 21.

(3) The torque ripple compensation value computation unit 12 calculates the phase and the amplitude of the torque ripple compensation value for each order of the torque ripple based on the electrical angular velocity 24. Specifically, the torque ripple compensation value computation unit 12 calculates the phase and the amplitude of the torque ripple compensation value 25 for each order of the torque ripple so as to offset a phase deviation and an amplitude deviation between the torque command value 21 and the torque output of the motor 4 by using the torque ripple estimation map 201, the torque control response characteristic table 202, and the phase-amplitude compensation unit 203. With such a configuration, it is possible to accurately calculate the torque ripple compensation value 25 for compensating for the torque ripple occurring in the motor 4 for each order of the torque ripple.

(4) The torque ripple compensation value computation unit 12 can calculate the torque ripple compensation value 25 such that the amplitude of the torque ripple compensation value 25 decreases as the electrical angular velocity 24 increases in a case where the electrical angular velocity 24 is equal to or higher than the predetermined reference value. With such a configuration, in a case where the motor 4 rotates at a high speed, the processing load of the entire motor control device 1 can be optimized.

(5) The ripple amplitude upper limit value calculating unit 14 calculates the ripple amplitude upper limit value 27 based on the difference between the torque upper limit value 26 and the absolute value of the torque command value 21 by the absolute value calculation unit 311 and the subtractor 312. With such a configuration, it is possible to appropriately calculate the ripple amplitude upper limit value 27 corresponding to the torque upper limit value 26 and the torque command value 21.

(6) The torque ripple compensation value computation unit 12 calculates the phase and the amplitude of the torque ripple compensation value 25 for each order of the torque ripple. The amplitude adjustment unit 15 calculates the maximum amplitude of the torque ripple compensation value 25 based on the phase and the amplitude of the torque ripple compensation value 25 calculated for each order by the amplitude optimization unit 101, and determines each of the amplitude-limiting order that is a target of the amplitude limitation among the orders and a limited amplitude of the torque ripple compensation value 25 for the amplitude-limiting order such that the maximum amplitude becomes equal to or lower than the ripple amplitude upper limit value 27. Then, the compensation value calculation unit 102 calculates the amplitude-adjusted torque ripple compensation value 28 based on the phase φna and the limited amplitude Ana of the torque ripple compensation value for the amplitude-limiting order, the phase on φn′ and the amplitude An′ (Ana) of the torque ripple compensation value for an order other than the amplitude-limiting order, and the magnetic pole position 23 of the motor 4. With such a configuration, it is possible to reliably calculate the amplitude-adjusted torque ripple compensation value 28 corresponding to the ripple amplitude upper limit value 27.

(7) The amplitude adjustment unit 15 determines the amplitude-limiting order sequentially from higher to lower orders in the amplitude optimization unit 101. With such a configuration, when suppressing the torque ripple occurring in the motor 4, a lower-order torque ripple component is preferentially suppressed, so that a greater torque ripple suppression effect can be obtained.

### Second Embodiment

Next, a second embodiment of the present invention will be described. Hereinafter, portions different from those of the first embodiment will be described, and a description of similar portions will be omitted.

In the first embodiment, as described above, an amplitude adjustment unit 15 of a motor control device 1 determines an amplitude-limiting order sequentially from higher to lower orders, so that a lower-order torque ripple component is preferentially suppressed. However, lower-order torque ripple does not necessarily have a higher amplitude depending on a structure and design of a motor 4. Therefore, in the present embodiment, the amplitude adjustment unit 15 of the motor control device 1 determines the amplitude-limiting order sequentially from an order having the lowest amplitude represented by a torque ripple compensation value 25, so that an order having a higher amplitude of the torque ripple is preferentially suppressed. Specifically, the amplitude-limiting order is determined in ascending order of the amplitude of the torque ripple compensation value 25 calculated for each order by a torque ripple compensation value computation unit 12 among respective orders n of the torque ripple.

Note that a configuration of the motor control device 1 according to the present embodiment is similar to that illustrated in the schematic block diagram of FIG. 1 described in the first embodiment.

According to the second embodiment of the present invention described above, the amplitude adjustment unit 15 determines the amplitude-limiting order in ascending order of the amplitude of the torque ripple compensation value 25 calculated for each order in an amplitude optimization unit 101. With such a configuration, when suppressing the torque ripple occurring in the motor 4, a torque ripple component having a higher is amplitude torque ripple preferentially suppressed, so that a greater suppression effect can be obtained.

### Third Embodiment

Next, a third embodiment of the present invention will be described. Hereinafter, portions different from those of the first embodiment will be described, and a description of similar portions will be omitted.

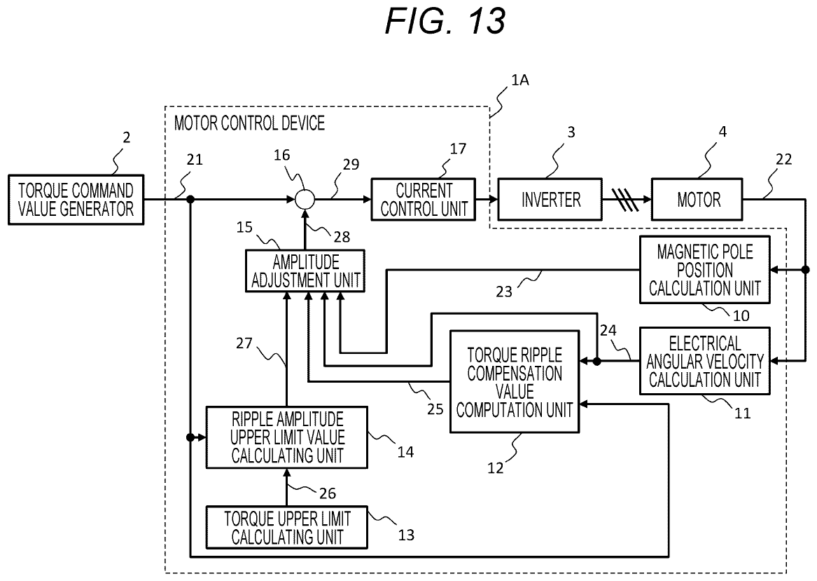

FIG. 13 is a schematic block diagram illustrating a configuration of a motor control device according to the third embodiment of the present invention. A motor control device 1A illustrated in FIG. 13 has the same configuration as that of the motor control device 1 according to the first embodiment illustrated in FIG. 1, but is different in that an electrical angular velocity 24 from an electrical angular velocity calculation unit 11 is also input to an amplitude adjustment unit 15.

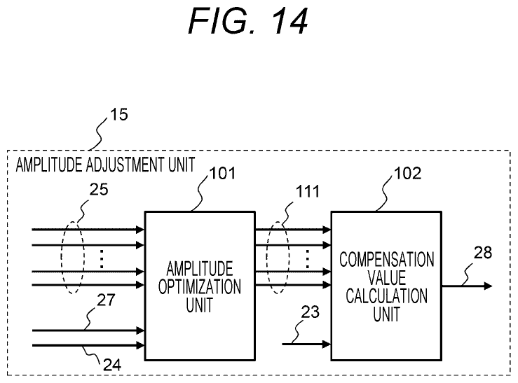

FIG. 14 is a block diagram of the amplitude adjustment unit 15 according to the third embodiment of the present invention. Similarly to FIG. 7 described in the first embodiment, in the present embodiment, the amplitude adjustment unit 15 includes an amplitude optimization unit 101 and a compensation value calculation unit 102.

In the present embodiment, in addition to a ripple amplitude upper limit value 27 output from a ripple amplitude upper limit value calculating unit 14, the electrical angular velocity 24 output from the electrical angular velocity calculation unit 11 is input to the amplitude optimization unit 101. The amplitude optimization unit 101 adjusts, based on these values, an amplitude of a torque ripple compensation value 25 for each order n output from a torque ripple compensation value computation unit 12, that is, an amplitude of each frequency component in the torque ripple compensation value 25 by a procedure different from that described in the first embodiment.

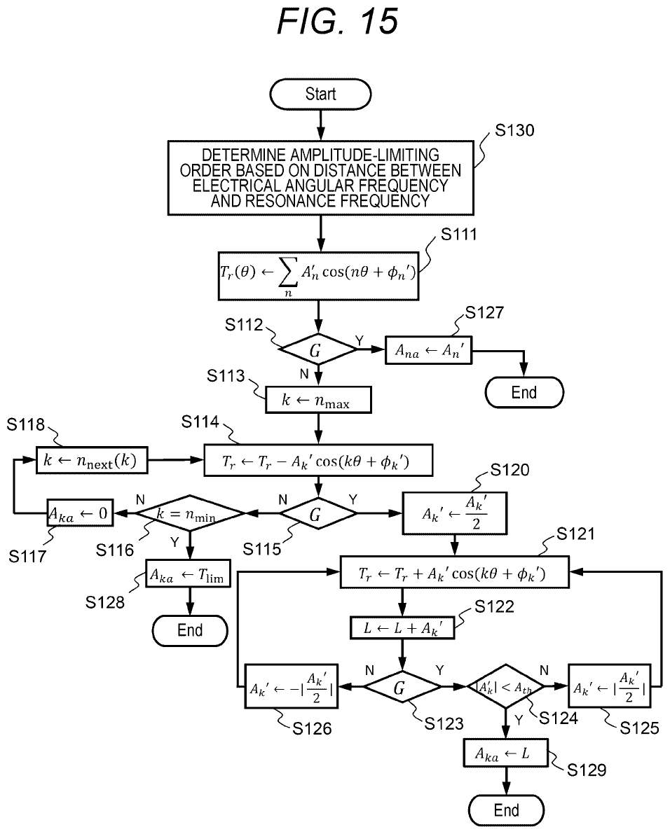

FIG. 15 is a flowchart illustrating an example of a method of adjusting the torque ripple compensation value 25 in the amplitude adjustment unit 15 according to the third embodiment of the present invention. The flowchart of FIG. 15 is different from the flowchart of FIG. 10 described in the first embodiment in that processing of step S130 is added before step S111.

In step S130, an electrical angular frequency of the motor 4 is calculated based on the electrical angular velocity 24 input from the electrical angular velocity calculation unit 11, and a frequency of torque ripple occurring in a motor 4 is obtained for each order n based on the electrical angular frequency. Then, an order of an amplitude-limiting order is determined based on a distance between the calculated frequency of the torque ripple for each order n and a resonance frequency of the motor 4.

Specifically, for example, the amplitude-limiting order is determined in descending order of a frequency difference with respect to the resonance frequency.

The motor 4 has the resonance frequency that causes mechanical resonance depending on mechanical characteristics of a target object that outputs a torque, a structure of the motor 4, a structure of a place where the motor 4 is installed, and the like. When the frequency of the torque ripple in the motor 4 matches the resonance frequency, vibration of the motor 4 is amplified, and sound and vibration generated when the motor 4 is driven increase. For example, in a case where the motor 4 is mounted on a vehicle such as an automobile, ride comfort of the vehicle deteriorates, and in a case where the motor 4 is used for a machine tool, machining accuracy deteriorates. As described above, the closer the frequency of the torque ripple occurring in the motor 4 is to the resonance frequency, the greater the influence on the vibration and noise of the motor 4.

Therefore, in the present embodiment, the amplitude adjustment unit 15 of the motor control device 1A calculates the electrical angular frequency of the motor 4 from the electrical angular velocity 24, obtains the frequency of the torque ripple for each order n, and determines the amplitude-limiting order sequentially from an order for which the frequency is the most different from the preset resonance frequency. As a result, the torque ripple of the order closer to the resonance frequency is preferentially suppressed.

In the present embodiment, an order of the amplitude-limiting order may be determined based on a reference other than the frequency difference from the resonance frequency. For example, in a case where a transfer function of a mechanical system in the motor 4 is known in advance, an amplitude after passing through the transfer function may be calculated for each amplitude An of the torque ripple for each order estimated by the torque ripple compensation value computation unit 12, and the amplitude-limiting order may be determined in ascending order of a value of the amplitude. Furthermore, in a case where the motor 4 drives a target object whose resonance frequency changes according to an operation condition, such as an elevator, for example, the resonance frequency can change according to the operation condition in the processing of step S130.

According to the third embodiment of the present invention described above, the amplitude adjustment unit 15 determines the amplitude-limiting order in descending order of a difference from the resonance frequency having a large influence on the vibration and noise of the motor 4. With such a configuration, when suppressing the torque ripple occurring in the motor 4, a torque ripple component having a larger influence on the vibration and noise generated in the motor 4 is preferentially suppressed, so that a greater torque ripple suppression effect can be obtained.

### Fourth Embodiment

Next, a fourth embodiment of the present invention will be described. Hereinafter, portions different from those of the first embodiment will be described, and a description of similar portions will be omitted.

A configuration of the motor control device 1 according to the present embodiment is similar to that illustrated in the schematic block diagram of FIG. 1 described in the first embodiment.

In the first embodiment, as described above, an amplitude adjustment unit 15 of a motor control device 1 determines an amplitude-limiting order sequentially from higher to lower orders, so that a lower-order torque ripple component is preferentially suppressed. However, for example, in a motor 4 mounted on a vehicle such as an automobile, it may be desired to minimize a maximum amplitude in a torque time waveform instead of a frequency component of torque ripple in order to minimize a deviation in acceleration in order to improve followability of a traveling trajectory for a speed command and a position command of the vehicle.

Therefore, in the present embodiment, the amplitude adjustment unit 15 of the motor control device 1 calculates an amplitude-adjusted torque ripple compensation value 28 such that a maximum amplitude of an output torque of the motor 4 corresponding to a final torque command value 29 in the time domain is minimized. Specifically, for example, an amplitude optimization unit 101 determines an adjusted amplitude compensation value Ana and an adjusted phase compensation value φna for each order n of the torque ripple by using an algorithm that solves an optimization problem represented by the following Formula (8).

$$[ Formula 8 ]$$

$$find {A}_{na} and {ϕ}_{na} which \qquad ( Formula 8 )$$

$$minimize {max}_{t ∈ [ 0 , 2 π / {ω}_{e} ]} {T}_{o} where {T}_{o} = {PT}_{r} ( t )$$

$${T}_{r} ( t ) = {\sum }_{n} {A}_{na} cos ( n {ω}_{e} t + {ϕ}_{na} )$$

$${max}_{t ∈ [ 0 , 2 π / {ω}_{e} ]} {T}_{r} \leq {T}_{lim}$$

In Formula (8), To represents an output torque waveform estimated for the final torque command value 29, P represents a transfer function from a torque command value 21 to the output torque, and we represents an electrical angular velocity 24 of the motor 4. In a case where it is difficult for the amplitude optimization unit 101 to perform the calculation of Formula (8) within a control period, Formula (8) may be calculated in advance, and the calculation result may be held in the amplitude optimization unit 101 as a map of the amplitude and the phase for each condition, so that the adjusted amplitude compensation value Ana and the adjusted phase compensation value φna may be determined by referring to the map.

According to the fourth embodiment of the present invention described above, the amplitude adjustment unit 15 calculates the amplitude-adjusted torque ripple compensation value 28 such that the maximum amplitude of the output torque of the motor 4 corresponding to the final torque command value 29 in the time domain is minimized in the amplitude optimization unit 101. In this way, in the motor 4 mounted on a vehicle such as an automobile, the deviation in acceleration of the vehicle can be minimized, and the followability of the traveling trajectory for the speed command and the position command of the vehicle can be improved.

### Fifth Embodiment

Next, a fifth embodiment of the present invention will be described. Hereinafter, portions different from those of the first embodiment will be described, and a description of similar portions will be omitted.

In a control design of a motor 4, a target value of a torque ripple amount to be achieved may be determined for each order. In the present embodiment, an example in which torque ripple is more preferentially suppressed for an order with a larger torque ripple excess amount from the target value in order to achieve the target value of the torque ripple amount as much as possible will be described.

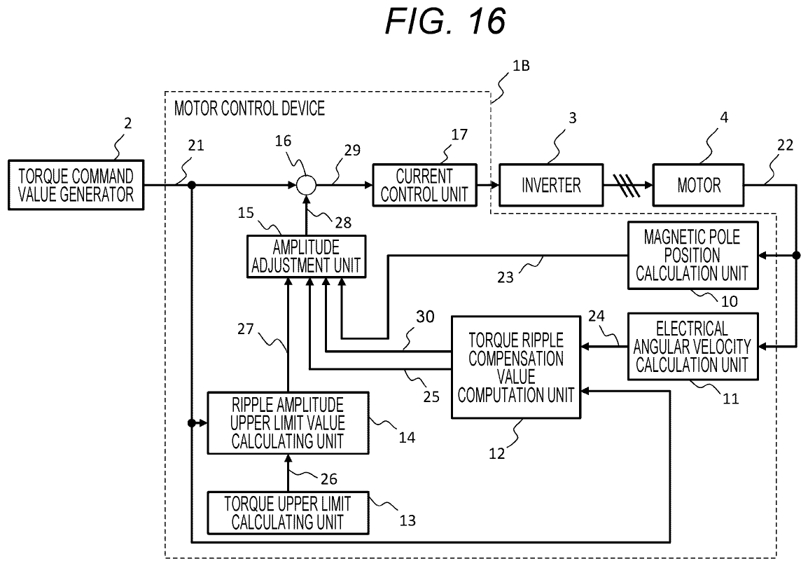

FIG. 16 is a schematic block diagram illustrating a configuration of a motor control device according to the fifth embodiment of the present invention. A motor control device 1B illustrated in FIG. 16 has the same configuration as the motor control device 1 according to the first embodiment illustrated in FIG. 1, but is different in that a torque ripple compensation value computation unit 12 calculates a torque ripple excess amount 30 in addition to a torque ripple compensation value 25, and these values are input to an amplitude adjustment unit 15. The torque ripple excess amount 30 is an excess amount of an amplitude of the torque ripple with respect to the target value preset for each order of the torque ripple, and is calculated for each order of the torque ripple in the torque ripple compensation value computation unit 12.

In the present embodiment, the amplitude adjustment unit 15 calculates an amplitude-adjusted torque ripple compensation value 28 based on the torque ripple compensation value 25 such that the torque ripple excess amount for each order represented by the torque ripple excess amount 30 become as small as possible. Specifically, an amplitude-limiting order is determined in ascending order of the torque ripple excess amount 30, and an adjusted amplitude compensation value Ana and an adjusted phase compensation value φna for each order (the amplitude-limiting order and each of other orders) are calculated. Then, amplitude and phase compensation values corresponding to a magnetic pole position 23 are obtained for each order n based on these calculation results. As a result, the amplitude-adjusted torque ripple compensation value 28 is calculated.

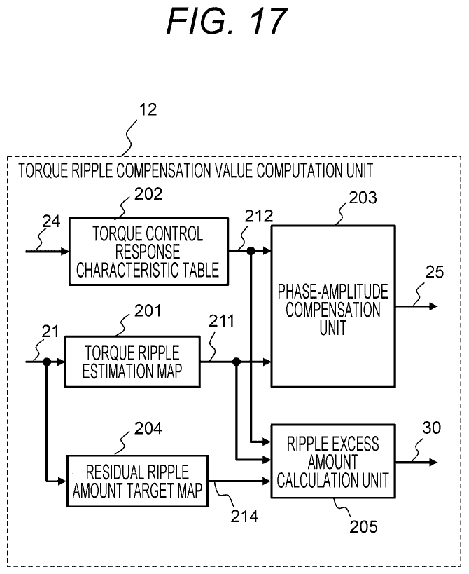

FIG. 17 is a block diagram of the torque ripple compensation value computation unit 12 according to the fifth embodiment of the present invention. In the present embodiment, the torque ripple compensation value computation unit 12 further includes a residual ripple amount target map 204 and a ripple excess amount calculation unit 205 in addition to a torque ripple estimation map 201, a torque control response characteristic table 202, and a phase-amplitude compensation unit 203 of FIG. 2 described in the first embodiment.

The residual ripple amount target map 204 holds the target value of the amplitude preset for each order n of the torque ripple. A designer of the motor control device 1 can determine, as the residual ripple amount target map 204 for each order, a magnitude of the amplitude of the torque ripple that is desired not to be exceeded as much as possible in a system including a motor 4.

The torque ripple compensation value computation unit 12 determines the target value of the amplitude for each order n of the torque ripple occurring in the motor 4 based on a torque command value 21 input from a torque command value generator 2 by referring to the residual ripple amount target map 204. Then, the determined target value of the amplitude for each order is input to the ripple excess amount calculation unit 205 as a residual ripple amount target value 214.

The ripple excess amount calculation unit 205 calculates a difference between an estimation result 211 for the amplitude of the torque ripple for each order obtained from the torque ripple estimation map 201 and the residual ripple amount target value 214 for each order n obtained from the residual ripple amount target map 204. Then, a ripple excess amount On for each order n is calculated by multiplying the obtained difference value by an amplitude compensation amount Gn represented by amplitude and phase compensation amounts 212 obtained from the torque control response characteristic table 202 for each order n. In addition, the ripple excess amount calculation unit 205 calculates a residual ripple compensation amount Rn for each order n by multiplying the residual ripple amount target value 214 for each order n obtained from the residual ripple amount target map 204 by the amplitude compensation amount Gn for each order n. The ripple excess amount On and the residual ripple compensation amount Rn calculated by the ripple excess amount calculation unit 205 are output as the torque ripple excess amount 30 from the torque ripple compensation value computation unit 12 to the amplitude adjustment unit 15.

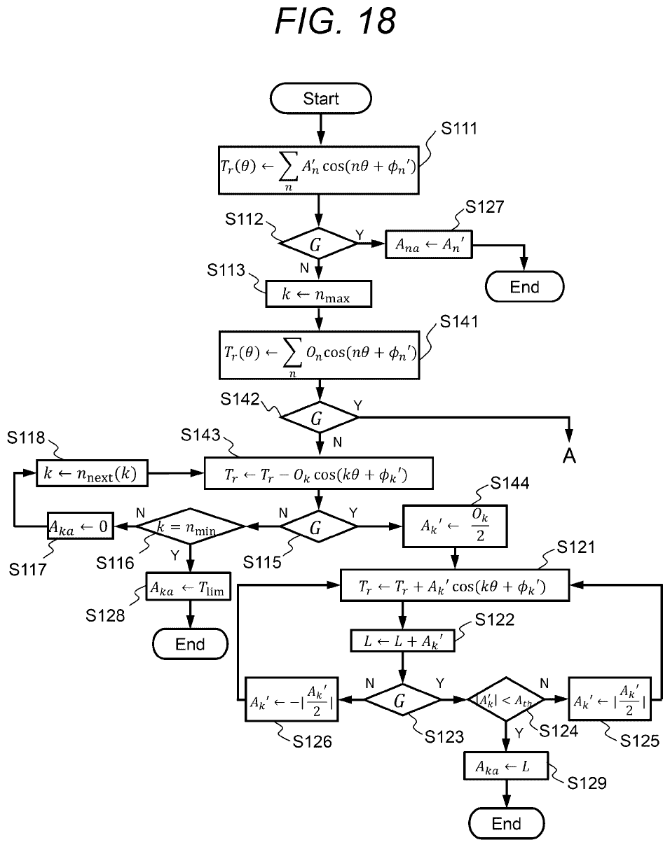

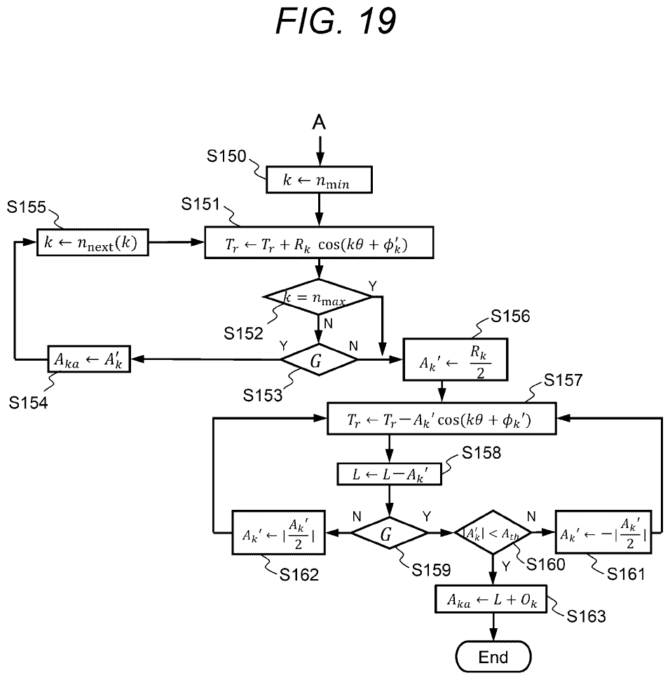

FIGS. 18 and 19 are flowcharts illustrating an example of a method of adjusting the torque ripple compensation value 25 in the amplitude adjustment unit 15 according to the fifth embodiment of the present invention. The flowcharts of FIGS. 18 and 19 illustrate a flow of processing in a case where an amplitude optimization unit 101 of the amplitude adjustment unit 15 adjusts the torque ripple compensation value 25 by using a two-stage amplitude adjustment algorithm using binary search.

In steps S111 to S113 and S127, processing similar to that in FIG. 10 described in the first embodiment is performed. However, in the present embodiment, in step S113, nmax represents an order with the smallest ripple excess amount On among the orders n of the torque ripple. After step S113, the processing proceeds to step S141.

In step S141, a torque ripple function Tr(θ) is recalculated based on the ripple excess amount On represented by the torque ripple excess amount 30 and a phase compensation value φn′ represented by the torque ripple compensation value 25. Here, the torque ripple function Tr(θ) is recalculated by replacing an amplitude compensation value An′ in the above Formula (4) with the ripple excess amount On.

In step S142, an evaluation formula G defined by the above Formula (5) is evaluated using the torque ripple function Tr(θ) recalculated in step S141. In a case where the evaluation result of step S142 is true (S142: Y), that is, in a case where the evaluation formula G is satisfied, the processing proceeds to step S150 of FIG. 19. On the other hand, in a case where the evaluation result in step S142 is false (S142: N), that is, in a case where the evaluation formula G is not satisfied, the processing proceeds to step S143.

In step S143, Okcos(kθ+φk′) corresponding to a ripple excess amount for an order corresponding to a current value of a variable k is subtracted from the torque ripple function Tr(θ), and the torque ripple function Tr(θ) in a case where the amplitude is reduced with the order of the ripple excess amount as the amplitude-limiting order is newly defined. The torque ripple function Tr(θ) redefined in step S143 corresponds to a result obtained by replacing Ak′ of the torque ripple function Tr(θ) redefined in step S114 in FIG. 10 with Ok.

After step S143, in steps S115 to S118 and S128, processing similar to that in FIG. 10 is performed based on the torque ripple function Tr(θ) redefined in step S143. However, in the present embodiment, in step S116, nmin represents an order with the largest ripple excess amount On among the orders n of the torque ripple. Furthermore, in step S118, an order with the second smallest ripple excess amount On following the order represented by the current value of the variable k is the second lowest order nnext(k) and is set as a new value of the variable k. In a case where the evaluation result in step S115 is true (S115: Y), that is, in a case where the evaluation formula G is satisfied, the processing proceeds to step S144.

In step S144, a half value of a ripple excess amount Ok for the order corresponding to the current value of the variable k is set as a new amplitude compensation value Ak′. At this time, a variable L is initialized to 0. After step S144, in steps S121 to S126 and S129, processing similar to that in FIG. 10 is performed based on the amplitude compensation value Ak′ set in step S144.

With the above operation, the amplitude adjustment of the torque ripple compensation value 25 with respect to the ripple excess amount On is completed. In step S150 and subsequent steps in FIG. 19, the amplitude of the torque ripple compensation value 25 is adjusted for the residual ripple compensation amount Rn.

In step S150, nmin is substituted into the variable k. In subsequent step S151, Rkcos(kθ+φk′) corresponding to the residual ripple compensation amount for the order corresponding to the current value of the variable k is added to the torque ripple function Tr(θ), and the torque ripple function Tr(θ) in a case where the amplitude of the residual ripple compensation amount is added is newly defined.

In step S152, it is determined whether or not the current value of the variable k is the order nmax with the smallest ripple excess amount On. In a case where k=nmax (S152: Y), the processing proceeds to step S156, and in a case where k≠nmax (S152: N), the processing proceeds to step S153.

In step S153, the evaluation formula G defined by the above Formula (5) is evaluated using the torque ripple function Tr(θ) redefined in step S151. In a case where the evaluation result in step S153 is true (S153: Y), that is, in a case where the evaluation formula G is satisfied, the processing proceeds to step S154. On the other hand, in a case where the evaluation result in step S153 is false (S153: N), that is, in a case where the evaluation formula G is not satisfied, the processing proceeds to step S156.

In step S154, the amplitude compensation value Ak′ for the order corresponding to the current value of the variable k is set as an adjusted amplitude compensation value Aka for the order. In subsequent step S155, the second lowest order nnext(k) following the order represented by the current value of the variable k is set as a new value of the variable k. After completion of step S155, the processing returns to step S151, and the same operation is repeated thereafter.

In step S156, a half value of a residual ripple compensation amount Rk for the order corresponding to the current value of the variable k is set as a new amplitude compensation value Ak′. In subsequent step S157, Ak′cos (kθ+φk′) corresponding to a torque ripple component for the order corresponding to the current value of the variable k is subtracted from the torque ripple function Tr(θ), and the torque ripple function Tr(θ) excluding the torque ripple component is newly defined.

In step S158, the amplitude compensation value Ak′ set in step S156 is subtracted from the variable L. In subsequent step S159, the evaluation formula G defined by the above Formula (5) is evaluated using the torque ripple function Tr(θ) newly defined in step S157. In a case where the evaluation result in step S159 is true (S159: Y), that is, in a case where the evaluation formula G is satisfied, the processing proceeds to step S160. On the other hand, in a case where the evaluation result in step S159 is false (S159: N), that is, in a case where the evaluation formula G is not satisfied, the processing proceeds to step S162.

In step S160, an absolute value of the amplitude compensation value Ak′ set in step S160 is compared with a threshold value Ath preset as an end condition of the binary search, and it is determined whether or not the absolute value | Ak′ | of the amplitude compensation value Ak′ is smaller than the threshold value Ath. In a case where | Ak′|<Ath (S160: Y), the processing proceeds to step S163. In step S163, the adjusted amplitude compensation value Aka for the order corresponding to the current value of the variable k is set to a value obtained by adding OK to the current value of the variable L, and the processing illustrated in the flowcharts of FIGS. 18 and 19 ends.

On the other hand, in a case where |Ak′ |≥ Ath (S160: N), the processing proceeds to step S161. In step S161, a value obtained by adding a minus sign to an absolute value of a half value of the amplitude compensation value Ak′ for the order corresponding to the current value of the variable k is set as a new amplitude compensation value Ak′. After completion of step S161, the processing returns to step S157, and the same operation is repeated thereafter.

In step S162, the absolute value of the half value of the amplitude compensation value Ak′ for the order corresponding to the current value of the variable k is set as a new amplitude compensation value Ak′. After completion of step S162, the processing returns to step S157, and the same operation is repeated thereafter.

The amplitude optimization unit 101 determines the adjusted amplitude compensation value Ana and the phase compensation value φna corresponding to the adjusted amplitude compensation value Ana for each order n of the torque ripple by repeatedly performing the processing illustrated in the flowcharts of FIGS. 18 and 19 described above until any end condition of steps S112, S116, S124, and S160 is satisfied.

According to the fifth embodiment of the present invention described above, the torque ripple compensation value computation unit 12 calculates the ripple excess amount of the torque ripple compensation value with respect to the preset residual ripple amount target value 214 for each order of the torque ripple in the ripple excess amount calculation unit 205. The amplitude adjustment unit 15 determines the amplitude-limiting order in ascending order of the ripple excess amount calculated for each order in the amplitude optimization unit 101. Therefore, when suppressing the torque ripple occurring in the motor 4, the torque ripple component with a larger torque ripple excess amount from the target value is preferentially suppressed, so that a greater torque ripple suppression effect can be obtained.

The present invention is not limited to the above-described embodiments, and various modifications can be made without departing from the gist of the present invention.

### REFERENCE SIGNS LIST

1, 1A, 1B motor control device
2 torque command value generator
3 inverter
4 motor
10 magnetic pole position calculation unit
11 electrical angular velocity calculation unit
12 torque ripple compensation value computation unit
13 torque upper limit calculating unit
14 ripple amplitude upper limit value calculating unit
15 amplitude adjustment unit
16 torque command value correction unit
17 current control unit

1. A motor control device that controls a motor based on a torque command value from a host controller, the motor control device comprising:
a torque ripple compensation value computation unit that calculates a torque ripple compensation value for compensating for torque ripple occurring in the motor based on an electrical angular velocity of the motor and the torque command value;
a ripple amplitude upper limit value calculating unit that calculates a ripple amplitude upper limit value which is an upper limit value for an amplitude of the torque ripple compensation value based on the torque command value and a torque upper limit value set for the motor; and
an amplitude adjustment unit that adjusts an amplitude of each frequency component in the torque ripple compensation value based on the ripple amplitude upper limit value and calculates an amplitude-adjusted torque ripple compensation value,
wherein a final torque command value for controlling the motor is calculated based on the amplitude-adjusted torque ripple compensation value calculated by the amplitude adjustment unit and the torque command value.

2. The motor control device according to claim 1, wherein the torque ripple compensation value computation unit estimates the torque ripple corresponding to the torque command value by using an estimation map in which an amplitude and a phase are recorded in advance in association with each other for each order of the torque ripple.

3. The motor control device according to claim 1, wherein the torque ripple compensation value computation unit calculates a phase and the amplitude of the torque ripple compensation value for each order of the torque ripple based on the electrical angular velocity.

4. The motor control device according to claim 3, wherein the torque ripple compensation value computation unit calculates a phase and the amplitude of the torque ripple compensation value for each order of the torque ripple so as to offset a phase deviation and an amplitude deviation between the torque command value and a torque output of the motor.

5. The motor control device according to claim 1, wherein the torque ripple compensation value computation unit calculates the torque ripple compensation value such that the amplitude of the torque ripple compensation value decreases as the electrical angular velocity increases in a case where the electrical angular velocity is equal to or higher than a predetermined reference value.

6. The motor control device according to claim 1, wherein the ripple amplitude upper limit value calculating unit calculates the ripple amplitude upper limit value based on a difference between the torque upper limit value and an absolute value of the torque command value.

7. The motor control device according to claim 1, wherein
the torque ripple compensation value computation unit calculates a phase and the amplitude of the torque ripple compensation value for each order of the torque ripple, and
the amplitude adjustment unit calculates a maximum amplitude of the torque ripple compensation value based on the phase and the amplitude of the torque ripple compensation value calculated for each order, determines each of an amplitude-limiting order that is a target of amplitude limitation among the orders and a limited amplitude of the torque ripple compensation value for the amplitude-limiting order such that the maximum amplitude becomes equal to or lower than the ripple amplitude upper limit value, and calculates the amplitude-adjusted torque ripple compensation value based on the phase and the limited amplitude of the torque ripple compensation value for the amplitude-limiting order, a phase and an amplitude of the torque ripple compensation value for an order other than the amplitude-limiting order, and a magnetic pole position of the motor.

8. The motor control device according to claim 7, wherein the amplitude adjustment unit determines the amplitude-limiting order sequentially from higher to lower orders.

9. The motor control device according to claim 7, wherein the amplitude adjustment unit determines the amplitude-limiting order in ascending order of the amplitude of the torque ripple compensation value calculated for each order.

10. The motor control device according to claim 7, wherein the amplitude adjustment unit determines the amplitude-limiting order in descending order of a difference from a frequency having a large influence on vibration or noise of the motor.

11. The motor control device according to claim 1, wherein the amplitude adjustment unit calculates the amplitude-adjusted torque ripple compensation value such that a maximum amplitude of an output torque of the motor corresponding to the final torque command value in a time domain is minimized.

12. The motor control device according to claim 7, wherein
the torque ripple compensation value computation unit calculates a ripple excess amount of the torque ripple compensation value with respect to a preset residual ripple amount target value for each order of the torque ripple, and
the amplitude adjustment unit determines the amplitude-limiting order in ascending order of the ripple excess amount calculated for each order.
